(19) United States
(12) Patent Application Publication
(10) Pub. No.: US 2013/0073123 A1
(43) Pub. Date: Mar. 21, 2013

(54) Energy Control Apparatus For Controlling Hybrid Energy Sources For An Aircraft

(71) Applicants: Andreas Westenberger, Buxtehude (DE); Lars Frahm, Halstenbek (DE); Till Marquardt, Hamburg (DE)

(72) Inventors: Andreas Westenberger, Buxtehude (DE); Lars Frahm, Halstenbek (DE); Till Marquardt, Hamburg (DE)

(73) Assignee: AIRBUS OPERATIONS GMBH, Hamburg (DE)

(21) Appl. No.: 13/616,055

(22) Filed: Sep. 14, 2012

Related U.S. Application Data
(63) Continuation of application No. PCT/EP2011/053097, filed on Mar. 2, 2011.
(60) Provisional application No. 61/313,897, filed on Mar. 15, 2010.

(30) Foreign Application Priority Data
Mar. 15, 2010 (DE) 10 2010 011 416.2

(51) Int. Cl. B64D 41/00; H02J 4/00; H02J 3/38

(52) U.S. Cl. CPC B64D 41/00; H02J 3/38; H02J 4/00; Y10S 903/903
USPC 701/3; 903/903

(57) ABSTRACT

An energy control apparatus for controlling hybrid energy sources for an aircraft is designed for determining an operating characteristic of an energy source, a demand of at least one first consumer for a first resource and a demand of a second consumer for a second resource. The energy control apparatus activates the energy source in dependence on the demand for the first resource and the second resource and, if there is no demand for a first or second resource that is generatable by the energy source and is present in excess, supplies a third consumer with the excess resource. This makes it possible for an energy system to operate different consumers independently of the type of generated resources and their dependencies during the generation.

### REFERENCE TO RELATED APPLICATIONS

The present application is a continuation of PCT application No. PCT/EP2011/053097, filed 2 Mar. 2011, claiming the priority of the U.S. Provisional Patent Application No. 61/313,897, filed 15 Mar. 2010, and of the German Patent Application No. 10 2010 011 416.2, filed 15 Mar. 2010, the disclosures of which applications are herewith incorporated herein by reference.

### TECHNICAL FIELD

The present invention relates to an energy control apparatus for controlling hybrid energy sources for an aircraft, an energy system for an aircraft, a method for controlling hybrid energy sources for an aircraft, as well as a use of an energy control apparatus in an aircraft and an aircraft with an energy control apparatus.

### BACKGROUND OF THE INVENTION

In addition to turbojet engines, modern aircraft frequently also comprise various types of other energy sources in order to relieve the engines, as well as the engine generators connected thereto, and to ultimately reduce the fuel consumption. Alternative energy sources such as, for example, solar cells, fuel cells or batteries may be used.

In order to increase the total energy balance of a commercial aircraft, it is attempted to utilize products and byproducts of different energy sources and hybrid energy sources such as, for example, heat, mass flows and the like.

DE 10 2007 013 345 A1 and WO 2008/113850 A2 describe an energy control apparatus for controlling several hybrid energy sources.

### SUMMARY OF THE INVENTION

The coupling of different energy sources and different consumers that require different resources for their operation may lead to dependencies in the operation of the consumers that are not always very advantageous. For example, if a first resource is made available by an energy source and a byproduct is supplied to another consumer, this byproduct is missing as soon as the first resource is no longer required by the consumer.

An aspect of the present invention provides for an increase in the efficiency of a hybrid energy generation system. Another aspect of the invention provides to maintain the reliability and operatability of such a hybrid energy generation system as soon as one or more consumers of the energy generation system require no energy or no resource. Yet another aspect of the invention provides an improvement in an energy control apparatus for controlling several hybrid energy sources to this effect.

According to an embodiment of the invention, an energy control apparatus for controlling hybrid energy sources for an aircraft is proposed, wherein the energy control apparatus is designed for determining a demand of at least one first consumer for a first resource and a demand of a second consumer for a second resource. At least the first resource and the second resource are simultaneously generatable by means of a hybrid energy source. The energy control apparatus controls the energy source in dependence on the demand for the first resource and a second resource such that the demand for the first resource and the second resource is met by the energy source. If there is no demand for a first or second resource that is generatable by the energy source and is present in excess, a third consumer is supplied with the excess resource.

The energy control apparatus according to the invention is preferably designed for determining the operating characteristic of the energy source in order to adapt the control. This makes it possible to realize a purposeful activation of the energy source in order to generate a sufficient quantity of the required resources or resource flows.

In this context, the term “resource” refers to a means that is required for the operation of a consumer and can be produced or made available by an energy source. Such a resource does not necessarily have to consist of a material, but may also be realized in the form of an electric current, heat or the like. The demand for a resource may be defined in the form of an absolute quantity, i.e., energy, volume, mass or the like, as well as in the form of a time derivative thereof, i.e., in the form of an output, a volume flow rate or a mass flow rate.

The term “operating characteristic” of an energy source refers to the general properties of an energy source and may consist, e.g., of the definition of a ratio between educts and products or resources, respectively. An operating characteristic may be defined by the quantity of educts introduced and the quantity of products delivered such as, e.g., electrical energy, thermal energy and other products. The operating characteristic may also be affected by ambient conditions such as pressure, temperature or relative humidity. The efficiency of a device or an energy source are also determinable with the aid of the operating characteristic. The highest efficiency is achieved at an operating point, at which the largest quantity of desired products such as, e.g., electrical energy is obtained from a certain quantity of educts. The operating characteristic may provide clues, for example, as to which operating parameter of the energy source such as the educt supply, valve positions or the like needs to be influenced in which way in order to make available or produce the required resource in the desired fashion.

In other words, an embodiment of the present invention includes an energy control apparatus that is able to increase the efficiency of the aircraft to the effect that one common energy source can operate several consumers that require different resources. Since the required energy for a first consumer or a second consumer empirically is not uniform over the entire duration of a mission or flight, the energy control apparatus according to an embodiment of the invention can supply a third consumer with an excess resource such that the energy source is able to realize a continuous and uninterrupted operation. By the third consumer as a resource sink for an excess resource the normal operation of the energy source and hence of the first and second consumers is ensured.

The interaction with respect to an electric or thermodynamic efficiency or with respect to the byproducts of energy sources can be improved with the energy control apparatus according to the invention such that the total energy balance of the aircraft is optimized.

The type of the third consumer is not necessarily prescribed in this context. However, this third consumer may preferably be designed for receiving a plurality of different resources in order to ensure a regular operation or to at least remove an excess resource. A few of several possible types of the design or the nature of the third consumer are discussed in greater detail further below.

The formulation “first consumer” and “second consumer” does not mean that the energy control apparatus according to the invention is merely able to always control only one single first consumer and only one single second consumer. This formulation should be interpreted in such a way that at least two different types of consumers in an aircraft can be supplied with energy or resources by an energy source, but does not rule out that an arbitrary number of other consumers requiring different types of resources may also be arranged in the aircraft. Likewise, the first consumer and the second consumer may also be combined into a system or subsystem that requires several resources for its operation such that the first consumer and the second consumer form a functional unit of individual cooperating consumers that cannot be separated as such.

The energy control apparatus according to an embodiment of the invention makes it possible to always realize the proper operation of the energy source and therefore all consumers, wherein the power of the energy source may be adapted to the effect that the respective first or second consumer with the greatest demand for resources decisively affects the operation of the energy source and all excess resources, byproducts and the like are consumed or removed by the aforementioned third consumer that may also consist of a plurality of different third consumers.

According to another embodiment of the invention, the third consumer is designed for being additionally supplied with a third resource. With respect to the energy control apparatus, this means that a third resource is supplied to the third consumer for the operation thereof, for example, when the first consumer and the second consumer are not in operation, wherein this is possibly more efficient than the operation of the energy source and the delivery of the first and the second resource. If no excess resource is present and the resources made available are completely consumed during the conventional operation of the energy source, the operation of the third consumer may be realized more efficiently with a different type of resource that is specific to the third consumer.

According to an embodiment of the energy control apparatus according to the invention, a resource is selected from the group consisting of electrical energy and byproducts, wherein the byproduct is selected from the group consisting of water, thermal energy and low-oxygen exhaust air. This combination of different resources can supply various types of consumers such that, for example, a main consumer requires electrical energy while other consumers rather need water, thermal energy or low-oxygen exhaust air. The low-oxygen exhaust air may be used for inerting rooms, the thermal energy may be used for deicing surfaces of the aircraft that are subjected to the airflow and the water may be used, for example, for supplying sanitary installations.

According to another embodiment of the invention, the energy control apparatus is designed in such a way that the demand for the first resource and the demand for the second resource is determinable in dependence on the flight phase. For example, different consumers and devices in an aircraft may be put at a disadvantage during critical flight phases such as take-off and landing to the effect that merely a basic function remains ensured, but these consumers are in this case also not subjected to any excessive demands during these flight phases.

According to another embodiment, the energy control apparatus is designed in such a way that the demand of another consumer for a third resource is measurable, wherein the third consumer is designed for receiving all excess resources. Due to this third consumer, the energy control apparatus according to the invention does not have to deliver all excess resources that are created as products or byproducts of a primary resource such as, for example, electrical energy to different consumers such that only a single third consumer or a single type of third consumer can be used as resource sink.

According to another embodiment, the energy control apparatus is designed in such a way that a priority is respectively assignable to the first consumer and the second consumer, wherein the energy control apparatus is realized such that the respective resource can be supplied to the first consumer and the second consumer in dependence on the priority. A low priority may be assigned, for example, if the main purpose of a second consumer merely consists of realizing an infrequently used comfort function. For example, if it is not planned to operate the first consumer over an extended period of time and a resource is only available to the second consumer when the first consumer requires this first resource, it may be advantageous with respect to the energy consumption to merely operate the second consumer with reduced power or not at all over an extended period of time. In such an instance, the second consumer may be assigned a lower priority than the first consumer.

According to another embodiment of the invention, the energy control apparatus may be designed in such a way that the priority is assignable with consideration of flight safety factors. As already mentioned above, this may conversely lead to safety-critical functions being assigned such a high priority that they may be maintained over the entire duration of the flight or mission. For example, a first or second consumer may consist of an inerting device for a tank or an extinguishing device that is designed for lowering the risk of an explosion or extinguishing fires by means of low-oxygen air and needs to be maintained operative under all circumstances. Low-oxygen air may be realized in the form of a secondary product or byproduct that is produced in addition to the primary resource. If a primary resource is not required by the primary consumers, it is supplied to the third consumer by the energy control apparatus according to the invention due to the high priority of the consumer requiring the secondary product or byproduct such that the third consumer can ensure the trouble-free function of the energy source and the continuous withdrawal of all resources.

An energy system according to an embodiment of the invention for an aircraft may comprise an energy control apparatus, at least one first consumer and at least one second consumer, as well as an energy source, wherein the energy control apparatus is designed for determining an operating characteristic of the energy source, as well as a demand of the first consumer for a first resource and a demand of the second consumer for a second resource, and wherein at least the first resource and the second resource are simultaneously generatable by means of the energy source. The energy control apparatus controls the energy source in dependence on the demand for the first resource and a second resource and, if there is no demand for a first or second resource that is generatable by the energy source and is present in excess, supplies a third consumer with the excess resource.

According to an advantageous embodiment, the first consumer and/or the second consumer is designed for making available a function to receive a first resource, as well as a second resource. This enables the energy system according to an embodiment of the invention, for example, to already supply an excess resource to the first or the second consumer. Such consumers may also be referred to as hybrid consumers.

It may generally be advantageous to realize several consumers in such a way that they tolerate a hybrid energy supply. In case of an electric supply within certain operating limits, these consumers should behave so neutral that other consumers aboard the aircraft are not negatively affected. For example, such consumers may not only receive electrical energy in order to locally generate heat, but also waste heat of an energy source that is conveyed onward to a certain location.

It may furthermore be particularly advantageous to alternatively or additionally make available third consumers that are realized in the form of a resource storage reservoir and designed for temporarily receiving an excess resource, as well as once again releasing this resource on demand. Accordingly, the energy control apparatus according to an embodiment of the invention preferably is designed for activating at least one hybrid energy source in such a way that not only the instantaneous demand for required resources is met, but the storage state of such third consumers and therefore their suitability for making available the previously excess resource are also taken into consideration.

It may alternatively or additionally be possible to provide third consumers that essentially consume the excess resource without effect, for example, by discharging the resource into the surroundings of the aircraft.

An aircraft according to an embodiment of the invention with an energy control apparatus of the above-described type may comprise, for example, several consumers that can be operated with a hybrid energy supply. For example, excess electric power may be stored up to a certain safe limit in a water tank or a kerosene tank in the form of thermal power. Other consumers may be realized, for example, with batteries or pressure or vacuum vessels that can be recharged with excess electric power. Excess electric or thermal power may simultaneously be discarded into leading wing edges or other surfaces for deicing purposes.

### BRIEF DESCRIPTION OF THE FIGURES

Other characteristics, advantages and possible applications of the present invention result from the following description of the exemplary embodiments and the figures. In this respect, all described and/or graphically illustrated characteristics also form the object of the invention individually and in arbitrary combination regardless of their composition in the individual claims or their references to other claims. In the figures, identical or similar objects are furthermore identified by the same reference symbols.

FIG. 1 shows a first exemplary embodiment of the control apparatus according to the invention.

FIG. 2 shows a second exemplary embodiment of the energy control apparatus according to the invention.

FIG. 3 shows a third exemplary embodiment of the energy control apparatus according to the invention.

FIGS. 4a and 4b show a schematic block-based diagram of an method according to the invention.

FIG. 5 shows an aircraft with at least one energy control apparatus according to the invention.

### DETAILED DESCRIPTION OF EXEMPLARY EMBODIMENTS

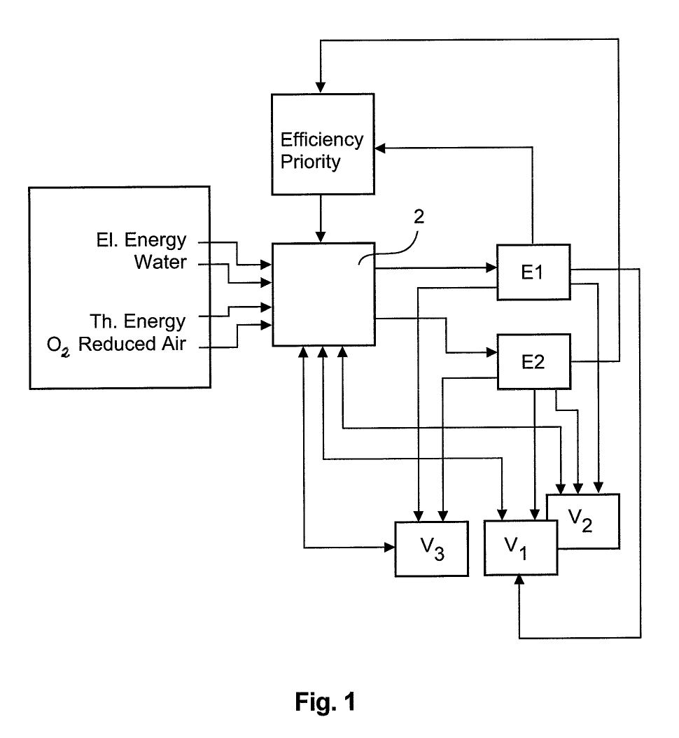

FIG. 1 shows a first exemplary embodiment of the energy control apparatus 2 that is designed for activating, for example, two energy sources E1 and E2.

The energy control apparatus 2 is designed for determining an operating characteristic of the energy sources E1 and E2. The energy control apparatus 2 is furthermore designed for determining a demand of at least one first consumer V1 for a first resource and a demand of at least one second consumer V2 for a second resource. The energy source E1 and/or E2 is able to simultaneously generate at least the first resource and the second resource. In this case, the energy control apparatus 2 controls the energy source E1 and/or E2 in dependence on the demand for the first resource and a second resource and, if there is no demand for a first or second resource that is generatable by the energy source E1 and/or E2 and is present in excess, supplies a third consumer V3 with the excess resource.

In order to ensure this function, the energy control apparatus 2 may determine the resources required by the consumers V1 and V2 by means of sensors, data transmission means or other means. In this context, it should be noted that the consumers V1, V2 and V3 may be realized, for example, in the form of direct current consumers, alternating current consumers, consumers of oxygen-depleted air (e.g., inerting systems), heat-consuming systems (e.g., deicing systems) and water-consuming systems (e.g., for the water supply in bathroom pods). Accordingly, the resources for these consumers therefore may consist of electric power in the form of a direct current or alternating current, a mass flow of oxygen-depleted air within a predefined temperature range, a heat flow with a predefined temperature level and a mass flow of water within a predefined temperature range. The instantaneously present resource flows may be determined by means of corresponding sensors while a consumer V1 or V2 may simultaneously communicate an instantaneous deficit of a resource flow to the energy control apparatus 2 by transmitting a corresponding signal via a signaling line or the like.

The number of consumers V1, V2 and V3 illustrated in the figures, as well as the number of energy sources E1 and E2, is chosen at random and should not be interpreted as being restrictive in any way.

In the exemplary embodiment shown, the energy source E1 is realized in the form of a fuel cell that converts supplied educts into an electric current, as well as byproducts in the form of a heat flow, oxygen-depleted air and a mass flow of water vapor. The energy control apparatus 2 is able to determine the operating characteristic of the energy source E1 by measuring the intensity of the electric current and the magnitude of the mass flow of water vapor and oxygen-depleted air. This in turn makes it possible to determine how an activation of the supply of educts may cause the fuel cell to vary, i.e., to increase or decrease, the products made available in order to counteract different resource flows.

The energy source E2 may be realized in the form of a conventional engine generator, the efficiency and maximum electric power of which are known. The maximum electric power that is generatable by the engine generator may furthermore be established by determining the speed of the engine and its ambient parameters that influence the shaft power that can be delivered to the engine generator.

Based on the information on the operating characteristics of the energy sources E1 and E2 and on the required resource flows, the energy control apparatus 2 is able to supply the consumers V1, V2 and V3 with the required resources by activating the energy sources E1 and E2 with consideration of the operating characteristics.

Due to the limited amount of energy available aboard an aircraft, it may, however, also be conceivable that a situation arises, in which it is not possible to make available sufficient resources required for the consumers V1, V2 and V3. This may be the case, for example, if the shaft power on the engine does not suffice for making available a sufficient amount of electric power or the like together with the fuel cell. Consequently, the energy control apparatus 2 is designed for respectively assigning a priority to the consumers V1, V2 and V3 and for supplying the largest portion of the required resource flow possible to the consumer with the highest priority while the other consumers V1, V2 and V3 with a lower priority receive smaller portions of the corresponding resource flow.

The energy control apparatus 2 is furthermore designed for activating the energy source E1 and/or E2 in such a way that excess resources can be consumed or discarded by the third consumer V3. This means that, for example, a consumer V1 or V2 with high priority causes the energy source E1 and/or E2 to be activated in such a way that the resource required for the consumer V1 or V2 is produced, wherein this is associated with the production of byproducts or primary products in the constellation shown. For example, the consumers V1 and V2 may require a heat flow or a mass flow of oxygen-depleted air that, however, can only be made available in the fuel cell E1 as soon as electric power is withdrawn. If it is not possible to consume the entire electric power, the energy control apparatus 2 can supply the remaining electric power to the connectable third consumer V3, in which it can then be consumed or discarded. This is the reason why the third consumer V3 can also be referred to as a blind/dummy consumer that consumes the excess resource without any adverse effects on the function and the safety of the aircraft.

It may generally be possible to discard the electric power by means of a conversion into a heat flow with the aid of thermoelectric elements or the like. The production of byproducts in the fuel cell E1 is maintained due to the “simulated” demand for electric power.

The third consumer V3 may consist, for example, of an electrothermal element that directly emits its produced heat into the outside air of the aircraft.

Alternatively, the third consumer V3 may directly or indirectly emit heat via an intermediate storage reservoir in the form of a water tank or a fuel tank, wherein the respective permissible operating limits need to be observed in these two options.

According to another alternative, the third consumer V3 itself may be realized in the form of a storage reservoir that temporarily stores, for example, oxygen-depleted air, water or electrical energy.

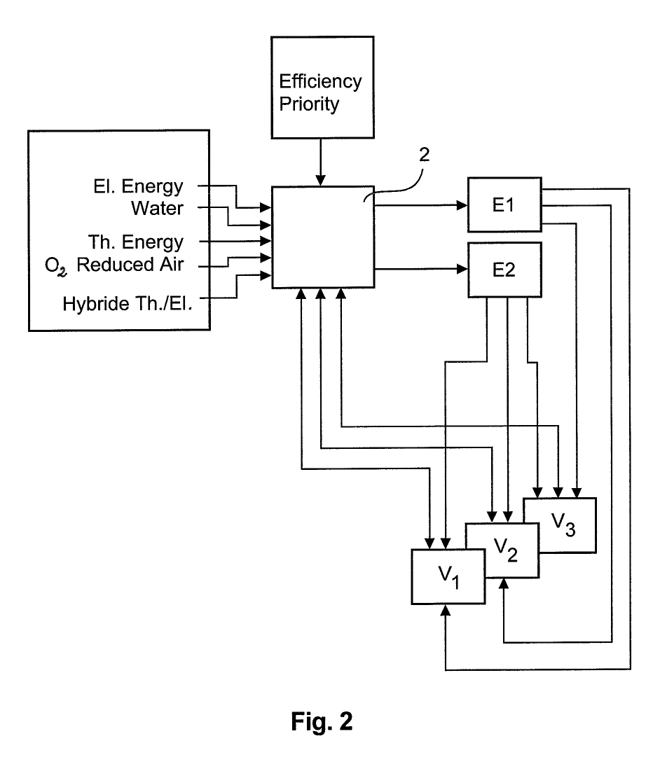

FIG. 2 shows a different embodiment, in which consumers V1, V2 and V3 are made available that can be supplied with resources in a hybrid fashion. This means that the consumers V1, V2 and V3 can be respectively operated with different resource flows or with a mixture of at least two different resource flows. In this case, the energy control apparatus 2 is preferably able to carry out the most optimal distribution of resources possible to the consumers V1, V2 and V3 based on the information on the operating characteristics of the energy sources E1 and E2 such that the produced quantity of excess resources to be discarded is as small as possible.

Such a hybrid consumer V1, V2 or V3 may be realized, for example, in the form of one or more deicing devices on leading wing edges that can be supplied with an electric current in order to generate heat, as well as with a flow-through heat transfer medium or another medium for the active transfer of a heat flow, such that they can emit heat to the leading wing edge or other exposed surface areas of the aircraft and dissolve ice situated thereon.

Another type of hybrid consumer V1, V2 or V3 may be realized, for example, in such a way that heat is generated in or supplied to a galley or other consumers in different ways.

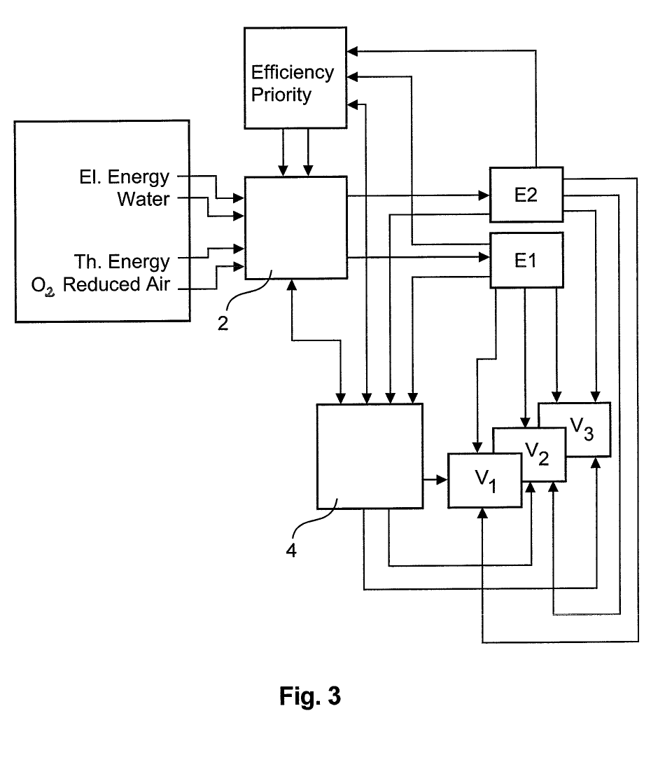

A third exemplary embodiment that is illustrated in FIG. 3 follows up on a different concept. In this case, excess resources in the form of electrical energy, water, air or the like can be stored in storage reservoir 4 in order to be released again at a different time or with a time delay. Electrical storage means may be realized in the form of accumulators, supercapacitors or similar means. Material products such as water or air can be received in storage containers such as, e.g., pneumatic or hydraulic accumulators, etc.

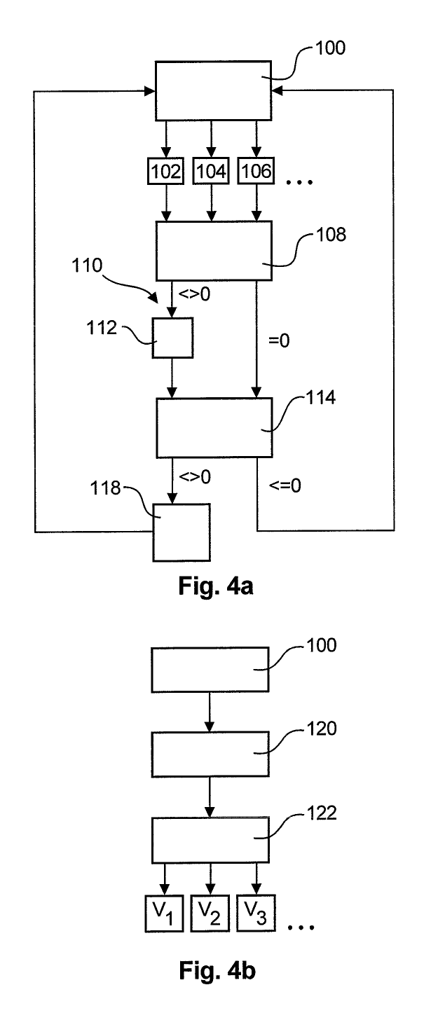

FIG. 4a shows a method according to an aspect of the invention in the form of a schematic block diagram. The method may comprise, for example, the determination 100 of operating characteristics. The demand for a first resource, a second resource, an optional third resource, etc., is determined 102, 104, 106, etc. In order to control the energy sources, it is necessary to determine 108 the deviation of the first resource, second resource, third resource, etc., that is instantaneously made available. If a deviation is detected 110, it is necessary to activate 112 the energy sources in such a way that the flow of the first resource, the second resource, the third resource, etc., is increased or decreased. Due to the nature of hybrid energy sources, this can inevitably lead to the increase of a resource flow also causing an increase of another resource flow although no corresponding demand exists. It is therefore proposed to determine 114 an excess resource flow. If an excess resource is present 116, it is supplied 118 to one or more third consumers.

FIG. 4b shows that the priority of the individual consumers is also checked 120 parallel to the distribution of resources such that, if a demand 100 for resources is detected, the available resources are distributed 122 to the individual consumers V1, V2, V3, etc., in accordance with the respective priority.

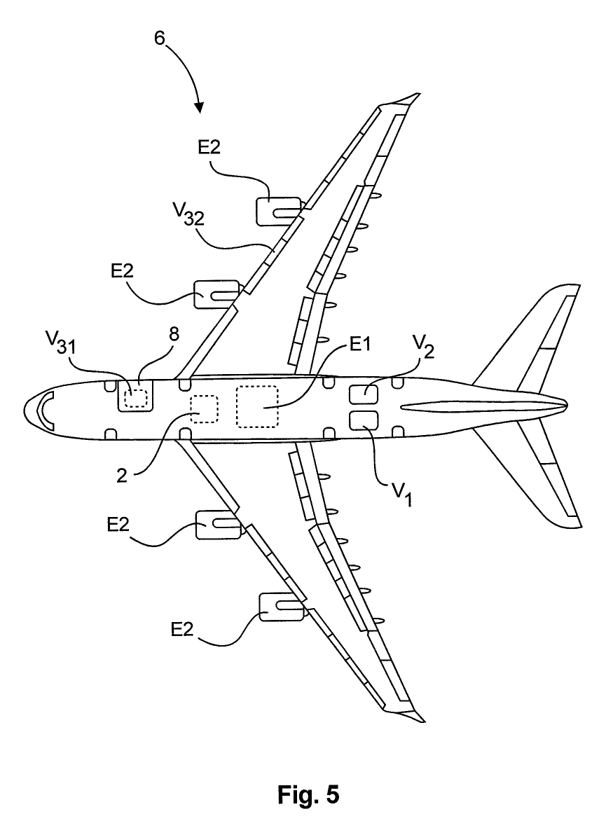

FIG. 5 shows an aircraft 6 that is equipped with energy sources in the form of engines identified by the reference symbol E2 and also comprises an additional energy source E1 in the form of a fuel cell. The energy control apparatus 2 according to the invention distributes resources to consumers V1, V2, V31 and V32, wherein the consumers V31 and V32 are considered to be “third consumers” in the context of the invention.

The consumer V31 may consist, for example, of a heating device in a galley 8 of the aircraft 6 that makes available heat by being supplied with several resources such as, e.g., electric power or a heat flow, wherein the latter may be made available by the fuel cell E1.

The consumer V32 may be realized in the form of heating devices on leading wing edges of the aircraft 6 in order to prevent the accumulation of ice thereon or dissolve accumulated ice. In this case, heat can be generated by means of a heat transfer from a heat flow of the fuel cell E1, as well as by supplying an electric heating device with an electric current. The consumer V32 may be operated with electrical energy if heat that should be made available by the fuel cell E1 is demanded otherwise in the aircraft 6.

As a supplement, it should be noted that “comprising” does not exclude any other elements or steps, and that “a” or “an” does not exclude a plurality. It should furthermore be noted that characteristics described with reference to one of the above exemplary embodiments can also be used in combination with other characteristics of other above-described exemplary embodiments. Reference symbols in the claims should not be interpreted in a restrictive sense.

### REFERENCE SYMBOLS

2 Energy control apparatus

4 Storage reservoir

6 Aircraft

8 Galley

100 Determining operating characteristics

102 Determining demand for a first resource

104 Determining demand for a second resource

106 Determining demand for a third resource

108 Determining deviations

110 Deviations present

112 Activating energy sources

114 Determining excess

116 Excess present

118 Supplying excess to third consumer

120 Checking priority

122 Distributing resources

E1 Energy source

E2 Energy source

V1 First consumer

V2 Second consumer

V3 Third consumer

V31 Third consumer

V32 Third consumer

1. An energy control apparatus for controlling hybrid energy sources for an aircraft,
wherein the energy control apparatus is configured for determining an operating characteristic of an energy source;
wherein the energy control apparatus is further configured for determining a demand of at least one first consumer for a first resource and a demand of a second consumer for a second resource;
wherein at least the first resource and the second resource are simultaneously generatable by at least one energy source;
wherein the energy control apparatus is configured to activate the energy source in dependence on the demand for the first resource and the second resource, and
wherein if there is no demand for the first or second resource generatable by the energy source and present in excess, the energy control apparatus is configured to supply the excess first or second resource to a third consumer.

2. The energy control apparatus of claim 1, wherein the third consumer is configured for being supplied with a third resource.

3. The energy control apparatus of claim 1,
wherein a resource is selected from the group consisting of electrical energy and at least one byproduct;
wherein the at least one byproduct is selected from the group consisting of water, thermal energy and low-oxygen exhaust air.

4. The energy control apparatus of claim 1,
wherein the energy control apparatus is configured in such a way that the demand for the first resource and the demand for the second resource is determinable in dependence on the flight phase.

5. The energy control apparatus of claim 1,
wherein the energy control apparatus is configured such a way that the demand of another consumer for a third resource is measurable;
wherein the third consumer is configured designed for receiving excess first or second or third resources.

6. The energy control apparatus of claim 1,
wherein the energy control apparatus is configured in such a way that a priority is respectively assignable to the first consumer, the second consumer and other consumers;
wherein the energy control apparatus is configured in such a way that the corresponding resource is supplied to the first consumer and the second consumer or other consumers in dependence on the priority.

7. The energy control apparatus of claim 6,
wherein the energy control apparatus is configured in such a way that the priority is assignable with consideration of flight safety factors.

8. The energy control apparatus of claim 1,
wherein the at least one energy source comprises a fuel cell system.

9. The energy control apparatus of claim 1,
wherein at least one of the first consumers and second consumers is selected from the group consisting of electrical direct current systems, electrical alternating current systems, water consumers, inerting systems and deicing systems.

10. An energy system for an aircraft, with the energy system comprising:
an energy control apparatus of;
at least one first consumer and at least one second consumer; and
an energy source;
wherein the energy control apparatus is configured for determining a demand of the first consumer for a first resource and a demand of the second consumer for a second resource;
wherein the energy control apparatus is configured for determining an operating characteristic of the energy source;
wherein at least the first resource and the second resource are simultaneously generatable by the energy source;
wherein the energy control apparatus is configured to activate the energy source in dependence on the demand for the first resource and the second resource, and
wherein if there is no demand for the first or second resource generatable by the energy source and present in excess, the energy control apparatus is configured to supply the excess first or second resource to a third consumer.

11. A method for controlling hybrid energy sources for an aircraft, with the method comprising:
determining a demand of a first consumer for a first resource and a demand of a second consumer for a second resource by an energy control apparatus;
determining an operating characteristic of an energy source by the energy control apparatus;
generating a first resource and a second resource by the energy source;
activating the energy source by the energy control apparatus in such a way that the first resource is made available to the first consumer and the second resource is made available to the second consumer in dependence on the operating characteristic; and
if there is no demand for the first or second resource generatable by the energy source and present in excess, supplying a third consumer with the excess first or second resource.

12. An aircraft with an energy control apparatus,
wherein the energy control apparatus is configured for determining an operating characteristic of an energy source;
wherein the energy control apparatus is further configured for determining a demand of at least one first consumer for a first resource and a demand of a second consumer for a second resource;
wherein at least the first resource and the second resource are simultaneously generatable by at least one energy source;
wherein the energy control apparatus is configured to activate the energy source in dependence on the demand for the first resource and the second resource, and
wherein if there is no demand for the first or second resource generatable by the energy source and present in excess, the energy control apparatus is configured to supply the excess first or second resource to a third consumer.
